(19) United States
(12) Patent Application Publication
(10) Pub. No.: US 2018/0059659 A1
(43) Pub. Date: Mar. 1, 2018

(54) Delivery System and Delivery Method

(71) Applicant: Hitachi, Ltd., Tokyo (JP)

(72) Inventors: Takashi TAKEUCHI, Tokyo (JP); Yoriko KAZAMA, Tokyo (JP); Ryosuke FUJIWARA, Tokyo (JP); Akira KURIYAMA, Tokyo (JP)

(21) Appl. No.: 15/614,790

(22) Filed: Jun. 6, 2017

(30) Foreign Application Priority Data
Aug. 23, 2016 (JP) 2016-162706

(51) Int. Cl. G05D 1/00; H04W 92/12

(52) U.S. Cl. CPC G05D 1/0022; B64C 2201/127; G05D 1/0061; H04W 92/12

(57) ABSTRACT

To provide a delivery system by which an unmanned aerial vehicle can be safely landed at a landing site, and the unmanned aerial vehicle can be landed at the desired site with high accuracy, a delivery system, comprising: an unmanned aerial vehicle that delivers a package to a delivery destination; a control server that manages delivery of the package; and an access point set in a vicinity of a landing site of the unmanned aerial vehicle, wherein the unmanned aerial vehicle is configured to: communicate with the control server through the access point when inside a predetermined range; and communicate with the control server through a telecommunications carrier network outside of the predetermined range.

### CLAIM OF PRIORITY

The present application claims priority from Japanese patent application JP 2016-162706 filed on Aug. 23, 2016, the content of which is hereby incorporated by reference into this application.

### BACKGROUND OF THE INVENTION

The present invention relates to a system that controls the operation of an unmanned aerial vehicle.

The following prior art exists as background art of the present technical field. JP 2016-76812 A discloses a wireless LAN access point system that improves a wireless LAN environment by moving a wireless AP. US 2015/0120094 A discloses a system in which an unmanned aerial vehicle that autonomously delivers inventory to various destinations receives inventory information as well as the location of the destination, autonomously calculates the route from the warehouse from which to acquire the merchandise to the destination, and delivers the product to the destination.

### SUMMARY OF THE INVENTION

In the above-mentioned conventional techniques, a landing site is acquired by a camera or the like installed in the unmanned aerial vehicle, thereby detecting the location at which to land. However, if the positioning accuracy is low and the camera angle is narrow, there are cases in which detection of the landing site is difficult.

An object of the present invention is to provide a delivery system by which an unmanned aerial vehicle can be safely landed at a landing site, and the unmanned aerial vehicle can be landed at the desired site with high accuracy.

The representative one of inventions disclosed in this application is outlined as follows. There is provided a delivery system, comprising: an unmanned aerial vehicle that delivers a package to a delivery destination; a control server that manages delivery of the package; and an access point set in a vicinity of a landing site of the unmanned aerial vehicle. The unmanned aerial vehicle is configured to: communicate with the control server through the access point when inside a predetermined range; and communicate with the control server through a telecommunications carrier network outside of the predetermined range.

According to representative aspects of the present invention, it is possible to detect the landing site with high accuracy. Problems, configurations, and effects other than those described above are made clear from the following description of an embodiment of this invention.

### BRIEF DESCRIPTION OF THE DRAWINGS

The present invention can be appreciated by the description which follows in conjunction with the following figures, wherein:

FIG. 1 is a diagram illustrating an overall configuration of a delivery system involving an unmanned aerial vehicle of a first embodiment;

FIG. 2A is a block diagram illustrating a configuration of the delivery system of the first embodiment;

FIG. 2B is a block diagram illustrating a physical configuration of a server set up in a control center of the first embodiment;

FIG. 3 is a block diagram illustrating a logical configuration of the delivery system of the first embodiment;

FIG. 4 is a diagram illustrating an example of a configuration of a delivery command table of the first embodiment;

FIG. 5 is a sequence diagram illustrating processes to be executed by the delivery system of the first embodiment;

FIG. 6 is a diagram illustrating an overall configuration of a delivery system involving an unmanned aerial vehicle of a second embodiment;

FIG. 7 is a block diagram illustrating a configuration of the delivery system of a third embodiment;

FIG. 8 is a diagram illustrating an image outputted by a server of the control center of the third embodiment;

FIG. 9 is a block diagram illustrating an overall configuration of a delivery system involving an unmanned aerial vehicle of a fourth embodiment; and

FIG. 10 is a block diagram illustrating a configuration of the delivery system of the fourth embodiment.

### DETAILED DESCRIPTION OF THE PREFERRED EMBODIMENTS

Embodiments of the present invention will be explained below with reference to figures. In the present embodiment, an unmanned aerial vehicle 1 detects as a landing site 101 a desired site designated by a user 4 and communicates with a wireless LAN access point 2, thereby improving detection accuracy of the landing site 101.

<Embodiment 1>

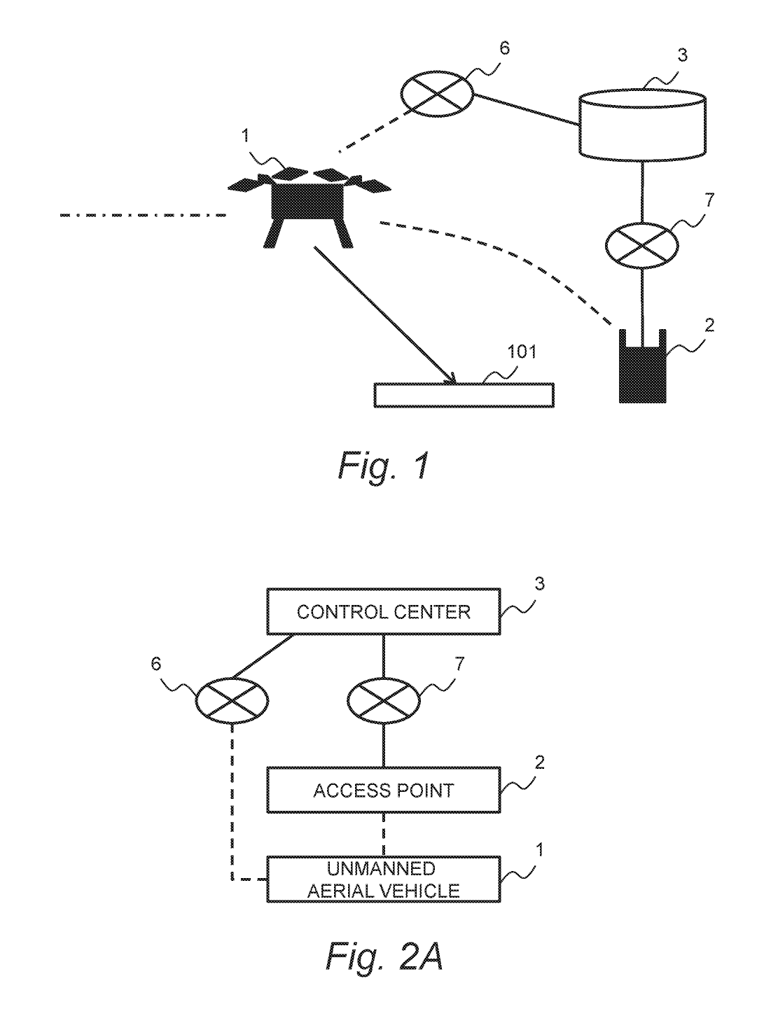

A first embodiment will be described with reference to FIGS. 1 to 5.

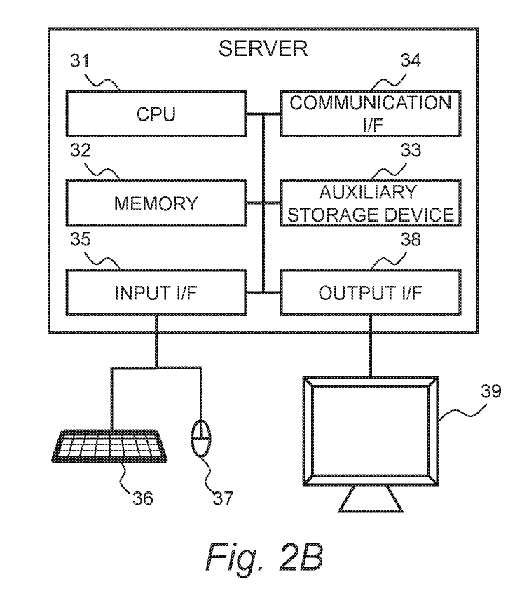

FIG. 1 is a diagram illustrating the overall configuration of a delivery system involving an unmanned aerial vehicle (such as a drone) 1 of the first embodiment, and FIG. 2A is a block diagram illustrating a configuration of the delivery system of the first embodiment.

The delivery system of the first embodiment includes the unmanned aerial vehicle 1, an access point 2, and a control center 3, and causes the unmanned aerial vehicle 1 to land at the landing site 101 designated by the user 4.

The unmanned aerial vehicle 1 is equipped with a wireless communication unit, a control unit, and a positioning unit (such as a GPS receiver), and includes the function of delivering a package by air. The unmanned aerial vehicle 1 communicates with the control center 3 wirelessly, and this wireless communication relies on a telecommunications carrier network 6 (such as a mobile phone network) or short-range wireless communication such by wireless LAN. However, a short-range wireless communication protocol other than wireless LAN (such as Bluetooth or ZigBee) may be used as the communication method. Additionally, an infrared beacon may be used instead of short-range wireless communication. Furthermore, a private wireless communication means may be used instead of the telecommunications carrier network 6. The unmanned aerial vehicle 1 may be equipped with cameras for capturing images therearound and a sensor unit such as a weather-monitoring sensor (such as a wind gauge, a temperature sensor, or a microparticle sensor). By such sensor units, it is possible to acquire the state of the landing site 101 or the environmental state. Also, weather data gathered by the unmanned aerial vehicle 1 during flight may be used to contribute to weather forecasting.

The control unit of the unmanned aerial vehicle 1 is configured with a general computer, and includes a processor that executes programs, and a non-volatile storage device (non-transitory storage medium) for storing programs and data. The flight function and package-holding function of the unmanned aerial vehicle 1 are controlled by the processor executing programs stored in the non-volatile storage device.

The user 4 sets up the access point 2 and the unmanned aerial vehicle 1 is guided to a desired location by communicating with the access point 2. The access point 2 simply needs to include a communication function as a wireless LAN base station, and may be a wireless LAN router having a routing function. The access point 2 may be set up at a destination (user's residence or office, or a delivery pickup point) to which a transportation or delivery business that operates the unmanned aerial vehicle 1 is to deliver the package.

The access point 2 may be a terminal (smartphone, tablet device, laptop computer) possessed by the user 4 instead of a fixed position wireless base station. In such a case, the terminal would operate in tethering mode as a wireless LAN access point. In such a case, a specialized application program installed in the terminal would communicate with the control center 3.

The user 4 issues a package delivery request to the control center 3 to send a predetermined package.

The control center 3 includes a delivery control server that receives information pertaining to the package to be delivered and the request from the user 4, plans a delivery route for the unmanned aerial vehicle 1, and issues a command to the unmanned aerial vehicle 1 to deliver the package.

The control center 3 notifies the user 4 of the delivery state and information regarding the package.

The control center 3 may include an online shopping server. The online shopping server receives a purchase request for a product from the user 4 and issues a command to the delivery control server to deliver the product. The online shopping server may include a payment function. In such a case, the product may be paid for once delivery of the product is complete. The purchase request from the user 4 may be transmitted to the control center 3 (online shopping server) through the access point 2.

The package delivery request sent by the user 4 includes the user identification of the user 4, the identification of the access point set up close to the user 4, and information of the destination (latitude and longitude). The control center 3 determines that the package designated by the user 4 should be delivered to the landing site 101 set by the user 4 via the unmanned aerial vehicle 1, sets a flight path for delivery, and issues a delivery command to the unmanned aerial vehicle 1. The delivery command issued to the unmanned aerial vehicle 1 includes a command identification for uniquely identifying the delivery command, a delivery destination (latitude and longitude, for example), the identification of the access point 2 set close to the destination, an unmanned aerial vehicle identification for uniquely identifying the unmanned aerial vehicle used for delivery, a package identification for uniquely identifying the package to be delivered, a user identification for uniquely identifying the user to receive the package, and the flight path. The flight path is designated by an array of node (waypoint) numbers as a path passing through one or more nodes set in advance on a map. Each node has set therefore location information including latitude, longitude, and altitude, and by assigning the node a unique node number, the transit point is uniquely set. Alternatively, a list of latitude, longitude, and altitude values may be used instead of node numbers. The method of indicating the route is not limited thereto as long as the method enables setting of one or more virtual points.

The unmanned aerial vehicle 1 communicates with the control center 3 through the telecommunications carrier network 6 during takeoff. When the unmanned aerial vehicle 1 approaches the access point 2 and enters an area in which it can receive signals transmitted from the access point 2, the unmanned aerial vehicle 1 communicates with the access point 2 by wireless LAN and the access point 2 communicates with the control center 3 through the internet 7. In other words, the unmanned aerial vehicle 1 communicates with the control center 3 through the internet.

FIG. 2B is a block diagram illustrating the physical configuration of a server set up in the control center 3 of the first embodiment.

The server of the control center 3 is configured with a computer having a processor 31 (CPU), a memory 32, an auxiliary storage unit 33, and a communication interface 34.

The processor 31 executes programs stored in the memory 32. The memory 32 includes ROM, which is a non-volatile memory device, and RAM, which is a volatile memory device. The ROM includes fixed programs (such as the BIOS). The RAM is a high speed and volatile memory device such as DRAM (dynamic random access memory), and temporarily stores programs to be executed by the processor 31 and data used during execution of the programs.

The auxiliary storage unit 33 is configured with a large capacity non-volatile storage device such as a magnetic storage device (HDD) or flash memory (SSD), for example, and stores programs to be executed by the processor 31 and data to be used while executing the programs. In other words, the programs are read from the auxiliary storage unit 33, loaded into the memory 32, and executed by the processor 31.

The communication interface 34 is a network interface unit that controls communication with other devices (unmanned aerial vehicle 1, etc.) according to a predetermined protocol.

The server may include an input interface 35 and an output interface 38. The input interface 35 is connected to a keyboard 36, a mouse 37, or the like and receives input from an administrator. The output interface 38 is connected to a display unit 39, a printer, or the like and outputs the server state and/or execution results of the program in a format readable by the administrator.

Programs executed by the processor 31 are provided to the server through removable media (such as CD-ROMs and flash memory) or through a network, and are stored in the non-volatile auxiliary storage unit 33, which is a non-transitory storage medium. Thus, the server would include an interface for reading in data from removable media.

The server is a computer system configured with one physical computer or a plurality of logical or physical computers, and may be operated in virtual computers created in a plurality of physical computer resources. The programs executed in the server may operate in a different thread in the same computer.

In the server, all or some of the function blocks executed by the programs may be configured with a physical integrated circuit (such as a field-programmable gate array) or the like.

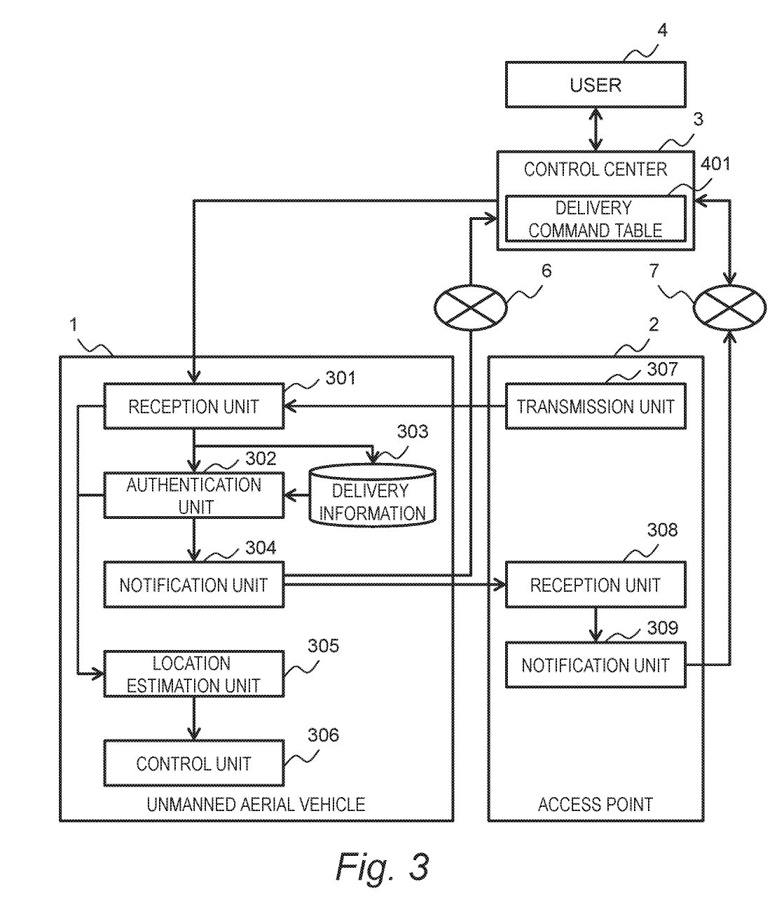

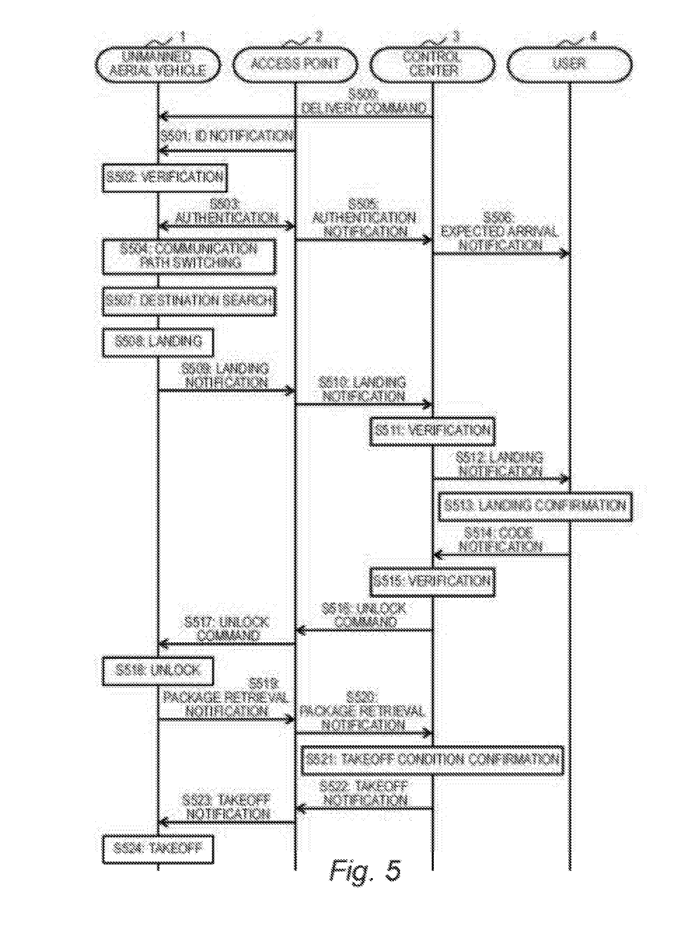

FIG. 3 is a block diagram illustrating a logical configuration of the delivery system of the first embodiment, and FIG. 5 is a sequence diagram illustrating processes to be executed by the delivery system of the first embodiment.
The unmanned aerial vehicle 1 includes a reception unit 301, an authentication unit 302, a delivery information accumulation unit 303, a notification unit 304, a location estimation unit 305, and a control unit 306. The access point 2 includes a transmission unit 307, a reception unit 308, and a notification unit 309.

The control center 3 transmits a delivery command to the unmanned aerial vehicle 1. The delivery command is stored in a delivery command table 401 stored in the server of the control center 3.

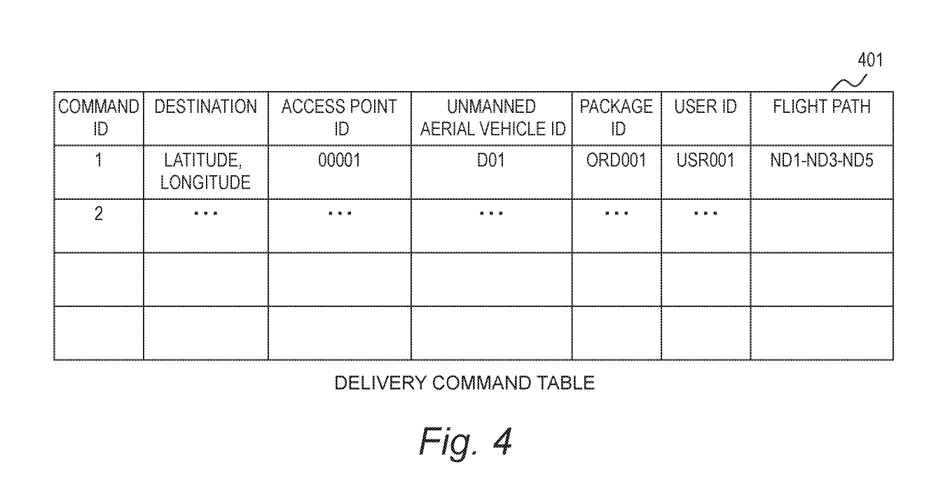

The delivery command table 401, as illustrated in the example of FIG. 4, includes a command identification for uniquely identifying the delivery command, a delivery destination (latitude and longitude, for example), the identification of the access point 2 set close to the destination, an unmanned aerial vehicle identification for uniquely identifying the unmanned aerial vehicle 1 used for delivery, a package identification for uniquely identifying the package to be delivered, a user identification for uniquely identifying the user 4 to receive the package, and the flight path. As described above, the flight path may be indicated by an array of node numbers with designated location information, or by a list of location information.

In the unmanned aerial vehicle 1, the reception unit 301 receives the aforementioned delivery command as delivery information from the control center 3 (S500). The reception unit 301 stores the received delivery command in the delivery information accumulation unit 303. The unmanned aerial vehicle 1 commences flight according to the delivery command, and during flight, the notification unit 304 issues as a notification the state of the unmanned aerial vehicle 1 (such as the location information acquired by the GPS receiver of the unmanned aerial vehicle 1, attitude information acquired by the gyro sensor, and the remaining battery life, for example) through the telecommunications carrier network 6 or the like.

A beacon is broadcast at a predetermined timing from the transmission unit 307 of the access point 2 (S501). The signal includes the identification (SSID, for example) of the access point 2. The identification of the access point 2 may be a specialized identification embedded in a packet instead of an SSID as defined in IEEE 802.11. The identification of the access point 2 may be changed in the middle of delivery by a command from the control center 3. In such a case, the control center 3 may designate a new identification for the access point 2, or the control center 3 and the access point 2 may generate a new identification according to a common rule (on the basis of an accurate clock, for example). Furthermore, the identification may be generated in association with the identification of the user 4 (so as to include a portion of the user ID, for example).

When the unmanned aerial vehicle 1 enters an area where it can receive signals transmitted from the access point 2, the reception unit 301 receives the signal from the transmission unit 307 of the access point 2. The reception unit 301 sends the identification of the access point 2 included in the received signal to the authentication unit 302.

The authentication unit 302 verifies the identification of the access point 2 received by the reception unit 301 against the identification of the access point 2 at the destination included in the delivery command stored in the delivery information accumulation unit 303 (S502). In this manner, even in a case where a plurality of access points are set in close proximity to each other, it is possible to identify the destination access point 2.

In a case where, as a result of verification by the authentication unit 302, the received identification of the access point 2 is found to match the identification of the access point 2 at the destination stored in the delivery information accumulation unit 303, then the notification unit 304 transmits an encryption key to the access point 2 and performs authentication with the access point 2 (S503).

In a case where authentication between the unmanned aerial vehicle 1 is successful and the access point 2 is successful, the unmanned aerial vehicle 1 switches its communication path with the control center 3 from the telecommunications carrier network 6 to the access point 2 (S504).

In a case where authentication between the access point 2 and the unmanned aerial vehicle 1 is successful, the notification unit 309 of the access point 2 issues a notification to the control center 3 through the internet 7 that the destination access point 2 has been acquired, authentication was successful, and that communication with the access point 2 has commenced (S505).

Since the identification of the access point 2 received by the unmanned aerial vehicle 1 matches the identification of the access point 2 set in advance for the destination, the control center 3 notifies the user 4 that the unmanned aerial vehicle 1 is expected to arrive (S506).

The reception unit 301 measures the strength of the signal received from the access point 2, and the location estimation unit 305 searches for the direction in which the strength of the signal received from the destination access point 2 is greater and causes the unmanned aerial vehicle 1 to fly in that direction while searching for the destination (S507).

The control unit 306 controls the flight of the unmanned aerial vehicle 1 so as to approach the landing site 101, with the access point 2 searched by the location estimation unit 305 as the destination. The landing site 101 includes a marker that can be recognized by a camera installed in the unmanned aerial vehicle 1, and the control unit 306 guides the unmanned aerial vehicle 1 towards the landing site 101 while recognizing the marker captured by the camera, and lands the unmanned aerial vehicle 1 (S508).

The unmanned aerial vehicle 1 notifies the control center 3 through the access point 2 that it has landed (S509, S510). The unmanned aerial vehicle 1 may be determined to include landed if its height relative to the surface of the ground is measured to be 0 by an altimeter installed in the unmanned aerial vehicle 1, or by detecting pressure on the legs of the unmanned aerial vehicle 1 as a result of landing.

The control center 3 verifies the identification of the landed unmanned aerial vehicle 1 and the identification of the access point 2 to ensure that they match the delivery command (S511), and in a case where it is confirmed that the package has been delivered by the designated unmanned aerial vehicle 1, then the user 4 is notified of the arrival of the unmanned aerial vehicle 1 (package) (S512). The arrival notification includes a code used to confirm arrival of the package. This code may be transmitted at a stage prior to arrival notification (such as in the expected arrival notification, when the order is placed, or when the delivery is received). The code may be randomly generated numerals or characters, numerals or characters unique to the unmanned aerial vehicle 1 (package), numerals or characters assigned uniquely to the delivery destination, or a bar code representing these codes.

In a case where the user 4 confirms landing of the unmanned aerial vehicle 1 (arrival of the package) (S513), the code issued by the control center 3 is transmitted back to the control center 3 (S514). The code may be inputted to a website provided by the control center 3, or the code may be inputted by a bar code representing the code being read in by a bar code reader installed in the unmanned aerial vehicle 1.

The control center 3 verifies whether the code inputted by the user 4 is correct (S515), and in a case where it is confirmed that the package has arrived at the correct destination by verification of the code, a command is issued to the unmanned aerial vehicle 1 through the access point 2 to unlock the package (S516, S517). The unmanned aerial vehicle 1 unlocks the package that it has carried as a result of the unlock command from the control center 3, and allows the user 4 to retrieve the package (S518).

Alternatively, a configuration may be adopted in which the user 4 inputs a code issued from the control center 3 to an input interface (keyboard, touch panel, or bar code reader) installed in the unmanned aerial vehicle 1, with the unmanned aerial vehicle 1 verifying the inputted code against a code stored in advance. In a case where the code is successfully verified, the unmanned aerial vehicle 1 may determine that the package has arrived at the correct destination, unlock the package carried therein, and the user 4 may retrieve the package. In this manner, the unmanned aerial vehicle 1 autonomously determines that it has arrived at the correct destination, and thus, it is possible to reliably hand the package to the user 4 without communication with the control center 3 (such as when communication with the control center is unstable).

In a case where the package is retrieved from the unmanned aerial vehicle 1, the unmanned aerial vehicle 1 notifies the control center 3 through the access point 2 that the package has been retrieved (S519, S520).

The control center 3 determines that takeoff conditions are satisfied in which the arrival confirmation code for the package is inputted by the user 4 and the notification by the unmanned aerial vehicle 1 that the package has been retrieved is confirmed (S521), and transmits a takeoff notification to the unmanned aerial vehicle 1 through the access point 2 (S522, S523).

In a case where the unmanned aerial vehicle 1 receives the takeoff notification, it departs towards the next destination (or the main base) (S524). Similar to the aforementioned delivery command, the takeoff notification transmitted to the unmanned aerial vehicle 1 includes a command identification, the destination location (latitude, longitude), the identification of the destination access point 2, the identification of the unmanned aerial vehicle used for the delivery, the identification of the package being delivered, the user ID, and the flight path.

As described above, in the first embodiment, by using a signal from the access point 2 in the vicinity of the landing site, it is possible to detect the landing site with high accuracy.

<Embodiment 2>

Next, a second embodiment of the present invention will be described. In the second embodiment, a wireless LAN access point 2 is installed in a pad 102, which serves as the landing site.

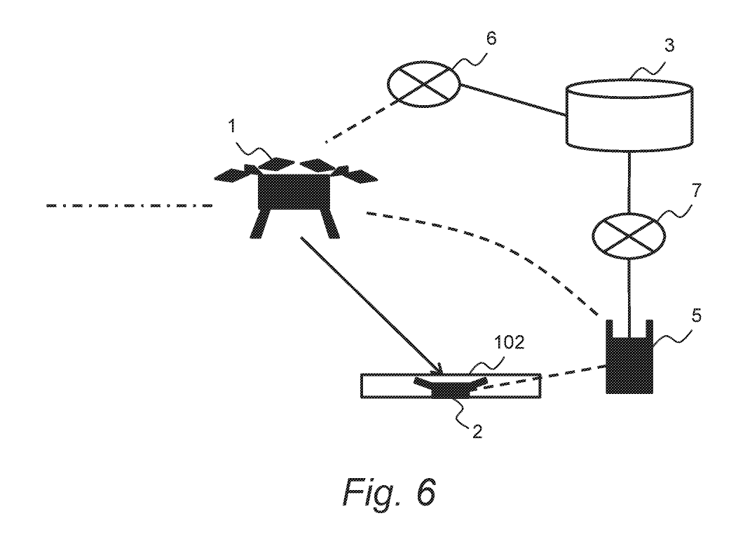

FIG. 6 is a diagram illustrating the overall configuration of a delivery system involving an unmanned aerial vehicle 1 of the second embodiment.

The pad 102 serving as the landing site displays a marker indicating the landing site in a manner allowing visual confirmation from the air. The unmanned aerial vehicle 1 lands on the landing site while recognizing the marker from above. The pad 102 is equipped with the access point 2, and the access point 2 is connected to an access point 5 that relays communications with a control center 3. The access point 2 may include a wired connection to the internet 7.

In the second embodiment, the access point 2 is set up at the landing site, and thus, a reception unit 301 of the unmanned aerial vehicle 1 receives a signal from the access point 2, a control unit 306 guides the unmanned aerial vehicle 1 towards the landing site by targeting a point with the strongest reception signal, and then lands the unmanned aerial vehicle 1. A location estimation unit 305 may calculate the relative distance between the access point 5 and the unmanned aerial vehicle 1 on the basis of the reception signal strength, with the control unit 306 guiding the unmanned aerial vehicle 1 towards the landing site so as to shorten the relative distance.

The access point 2 may include the function of changing the strength of the signal transmitted. In such a case, when guiding the unmanned aerial vehicle 1 towards the landing site, the access point 2 would first transmit the signal at maximum output and then gradually reduce output as the unmanned aerial vehicle 1 approaches. Thus, by gradually reducing the output strength of the transmission signal, the strength of the signal as received by the unmanned aerial vehicle 1 does not greatly change, which means that the receiver of the unmanned aerial vehicle 1 would not be saturated by a strong signal, enabling the unmanned aerial vehicle 1 to be appropriately guided to the landing site.

In a case where the unmanned aerial vehicle 1 lands on (or near) the pad 102, it notifies the control center 3 through the wireless LAN that it has landed.

The pad 102 may include a second communication function other than wireless LAN (such as an infrared beacon or Bluetooth, for example). In such a case, the unmanned aerial vehicle 1 includes a second communication function corresponding to the pad 102. First, the unmanned aerial vehicle 1 acquires the wireless LAN signal, and when it approaches the pad 102, it starts communication through the second communication function. In other words, it is preferable that the communication range of the second communication function be shorter than the communication range of the wireless LAN.

Also, in a case where the unmanned aerial vehicle 1 and the access point 2 include a plurality of communication functions, then the round trip communication time (RTT, for example) measured by the plurality of communication functions may be used to measure the distance between the access point 2 and the unmanned aerial vehicle 1. If, for example, the plurality of communication functions use differing wavelengths or transmission speeds such as the radio waves of the wireless LAN and ultrasonic waves, the distance can be accurately measured.

Also, the pad 102 may include the second communication function instead of the wireless LAN communication function (such as an infrared beacon or Bluetooth, for example). In such a case, the unmanned aerial vehicle 1 includes the second communication function corresponding to the pad 102. First, when the unmanned aerial vehicle 1 travels along a predetermined path and approaches the pad 102, it starts communication through the second communication function.

Also, the pad 102 may include a positioning unit (such as a GPS receiver) and transmit location information (latitude, longitude, elevation). In this manner, the unmanned aerial vehicle 1 can acquire the location of the pad 102, which was set in a desired location by the user 4. Also, the locations of the unmanned aerial vehicle 1 and the pad 102 relative to each other can be accurately calculated, and the unmanned aerial vehicle 1 can be accurately guided to the landing site.

As described above, in the second embodiment, the unmanned aerial vehicle is guided to the landing site by a signal from the pad 102, and thus, there is no need to provide a large marker to be recognized from the air at the landing site, and a small landing site that can be set up in a small location may be used. In other words, it is possible to miniaturize the pad 102.

### <Embodiment 3>

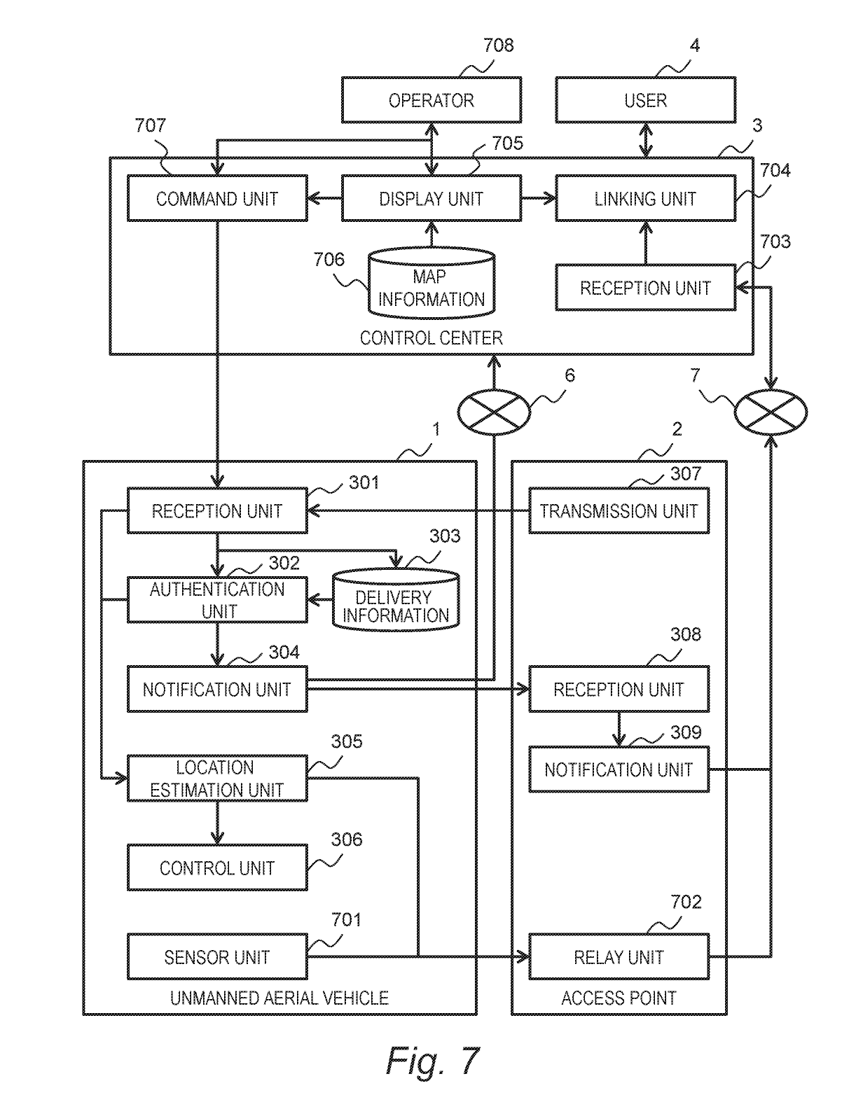

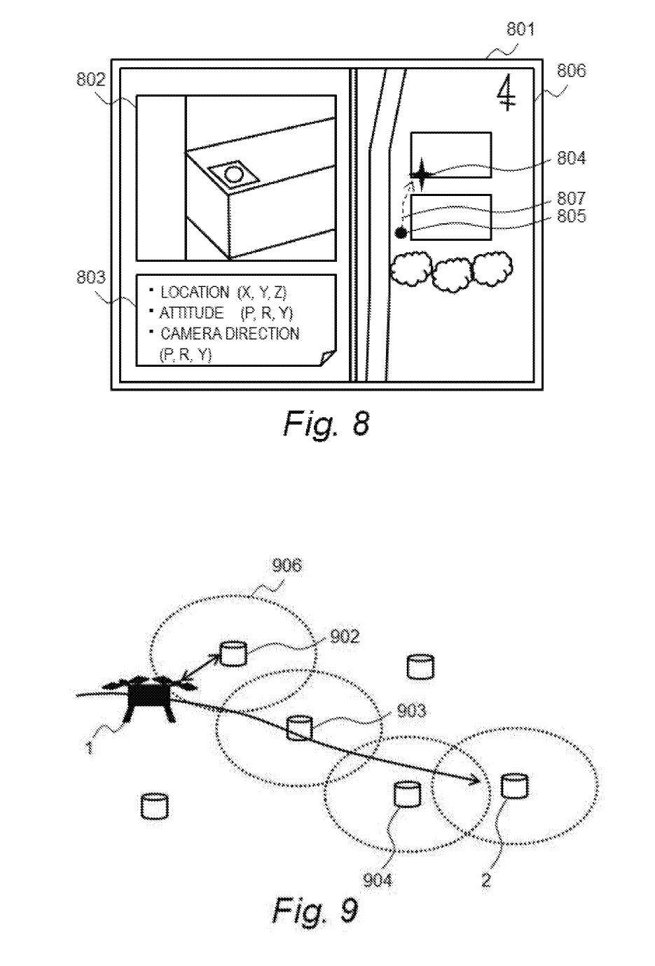

A third embodiment of the present invention will be explained next with reference to FIGS. 7 and 8. In the third embodiment, data acquired by a camera installed in an unmanned aerial vehicle 1 is transmitted to a control center 3 through a wireless LAN, and an operator controls the unmanned aerial vehicle 1 using the camera image.

FIG. 7 is a block diagram illustrating a configuration of the delivery system of the third embodiment, and FIG. 8 is a diagram illustrating an image outputted by the server of the control center 3 of the third embodiment.

The unmanned aerial vehicle 1 includes a sensor unit 701 in addition to the configuration of the first embodiment. An access point 2 includes a relay unit 702 that transmits image data and sensor data to the control center 3 from the unmanned aerial vehicle 1. The server of the control center 3 includes a reception unit 703 that receives image data and sensor data transmitted from the unmanned aerial vehicle 1, a linking unit 704 that estimates the range captured in the received image data, a display unit 705 that generates image data to be displayed to an operator 708 and outputs the image data, and a command unit 707 that creates flight commands according to piloting operations by the operator 708.

The sensor unit 701 of the unmanned aerial vehicle 1 includes a camera, the camera captures a still frame image or video footage of the surroundings of the unmanned aerial vehicle 1, and transmits the captured image to the access point 2, for example. The sensor unit 701 may transmit location information acquired by a GPS receiver or attitude information acquired by a gyro sensor.

The unmanned aerial vehicle 1 starts transmission of the image captured by the camera when it enters the communication range of the access point 2. Then, the operator 708 may switch from automatic landing mode to manual operation mode.

In a case where the unmanned aerial vehicle 1 does not recognize a landing site after it has searched for the landing site for a predetermined period of time within the communication range of the access point 2, it notifies the control center 3 that a landing site cannot be found. Then, the operator 708 switches to manual operation mode, searches for the landing site, and lands the unmanned aerial vehicle 1. Also, the unmanned aerial vehicle 1 may automatically switch to manual operation mode after notifying the control center 3 that a landing site cannot be found. In such a case, the unmanned aerial vehicle 1 would hover and remain in standby mode while awaiting flight instructions from the control center 3.

Additionally, areas where automatic flight would be difficult can be set in advance, with the unmanned aerial vehicle switching to manual operation mode when it enters the region where automatic flight is difficult. At this point, the unmanned aerial vehicle may automatically switch to manual operation mode, or may be switched to manual operation mode by the operator 708.

The relay unit 702 of the access point 2 transmits the image data received from the unmanned aerial vehicle 1 to the control center 3. The unmanned aerial vehicle 1 or the access point 2 may include the function of encoding the image data by compressing it, for example, in order to adjust the amount of data transmitted.

The reception unit 703 of the control center 3 receives the image data transmitted by the relay unit 702 through the internet 7. The reception unit 703 also receives the location information and attitude information of the unmanned aerial vehicle 1.

The linking unit 704 estimates the location of the unmanned aerial vehicle 1 and estimates the range captured in the received image data on the basis of the received image data, the location information, and the attitude information.

The display unit 705 displays the on-map location of the unmanned aerial vehicle 1 on a display screen on the basis of the transmitted image data and the image range information estimated by the linking unit 704. For example, a display screen 801 illustrated in FIG. 8 includes an image display region 802 that displays the image data captured and transmitted by the unmanned aerial vehicle 1, and a location/attitude display region 803 that displays the location and attitude of the unmanned aerial vehicle 1 and data regarding the direction that the camera is facing. The unmanned aerial vehicle 1 transmits the image data and the location information at a synchronized timing, and the image and location information are displayed in synchronization with each other. Also, the display screen 801 includes a map display region 806. The map display region 806 displays a map of the vicinity of the location where the unmanned aerial vehicle 1 is flying. The location 805 of the unmanned aerial vehicle 1 and the location 804 of the landing site, which is the destination, are displayed on the map. Additionally, a flight path 807 from the current location to the destination may be calculated and displayed on the map.

The map data is stored in advance in a map information accumulation unit 706. The map may be a two-dimensional map, an image linked with location information such as satellite imagery, or a three-dimensional map including data such as the height of obstacles such as buildings. Furthermore, the image transmitted from the unmanned aerial vehicle 1 may be linked with the map data to form a three-dimensional image. By superimposing and combining a plurality of images having offset positions, three-dimensional data of the captured images can be calculated. Also, a wide image may be created by a process to connect captured images to display the location in the wide image captured at a certain point in time. In this manner, even with narrow angle images, it is possible to easily know which location is being imaged.

The operator 708 operates the unmanned aerial vehicle 1 while viewing a peripheral image 802 and the location 805 of the unmanned aerial vehicle 1, which are displayed in the display screen 801. The unmanned aerial vehicle 1 may be operated by projecting a virtual unmanned aerial vehicle on a display screen such as in a simulator, with the operator operating the unmanned aerial vehicle 1 on the display screen using a controller.

The command unit 707 creates flight commands by the piloting operation by the operator 708 and transmits these commands to the unmanned aerial vehicle 1. The flight commands include the direction and speed of the unmanned aerial vehicle 1.

The control unit 306 of the unmanned aerial vehicle 1 controls the rotational speed of the blades and controls the flight according to commands received by the reception unit 301.

As described above, according to the third embodiment of the present invention, in a case where the terrain or building configuration at the landing site is complex, the landing site is difficult to see from the air, or the signal range of the access point 2 is short and the landing site cannot be found, then the unmanned aerial vehicle switches from automatic landing mode to manual operation by the operator 708. Near the landing site, image data captured by the camera is transmitted through a wireless LAN, which can transmit large volumes of data, enabling clear imagery to be seen by the operator during remote operation.

### <Embodiment 4>

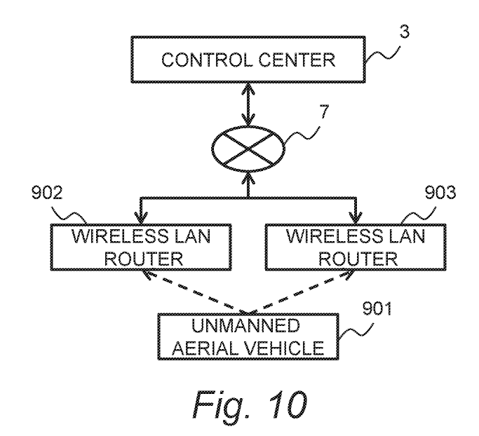

A fourth embodiment of the present invention will be explained next with reference to FIGS. 9 and 10. In the fourth embodiment, an unmanned aerial vehicle 1 communicates through a plurality of access points during flight.

FIG. 9 is a block diagram illustrating the overall configuration of a delivery system involving the unmanned aerial vehicle 1 of the fourth embodiment, and FIG. 10 is a block diagram illustrating a configuration of the delivery system of the fourth embodiment.

The unmanned aerial vehicle 1 flies towards the destination (access point 2). When the unmanned aerial vehicle 1 enters a communication range 906 of the access point 902, it receives a signal from the access point 902. The unmanned aerial vehicle 1 transmits the state of the unmanned aerial vehicle 1 (location information acquired by the GPS receiver of the unmanned aerial vehicle 1, attitude information, images captured by the camera, remaining battery life, etc., for example) to the control center 3 through the access point 902 and the internet 7.

As the unmanned aerial vehicle 1 flies, it exits the communication range of the access point 902, and enters the communication range of the access point 903. The unmanned aerial vehicle 1 switches from using the access point 902 to using the access point 903 and continues communication. Next, the unmanned aerial vehicle 1 switches from using the access point 903 to using the access point 904 and continues communication. The access point itself may include a handover function of switching access points without interruption of communication with the unmanned aerial vehicle 1, or the unmanned aerial vehicle 1 may establish communication with the access point 903 after communication with the access point 902 has been cut off.

The access point 2, which is a transit point for the unmanned aerial vehicle 1, holds setup location information (address, latitude, longitude). By comparing location information (GPS data) taken at a transit point that is closest to the access point 2 (with the strongest signal received) with data of the location where the access point 2 is set up, it is possible to determine the error in positioning of the unmanned aerial vehicle 1 and to improve positioning accuracy of the unmanned aerial vehicle 1.

A virtual access point can be used as the access point to be used for the unmanned aerial vehicle 1. For example, two access points (private access point and public access point) that transmit different SSIDs would be set, the unmanned aerial vehicle 1 would communicate with the public access point, and the owner of the access point would communicate with the private access point. In this manner, it is possible to separate communications by the unmanned aerial vehicle 1 from communications by the owner, enabling the unmanned aerial vehicle 1 to communicate with the control center 3 through the access point without violating the privacy of the access point owner.

Also, by the public access point performing authentication using an encryption key, it can allow access only from an unmanned aerial vehicle 1 set in advance, thereby preventing unwanted access to the access point or to the unmanned aerial vehicle 1.

The wireless LAN network of the public access point may be used by the user 4 in addition to the unmanned aerial vehicle 1. A user who has undergone a predetermined registration process (such as a member of an online shopping site) can access the public access point using a predetermined encryption key and transmit large volumes of data. In particular, the user 4 may issue a request to deliver a package or order a product to the control center 3 through a wireless LAN network formed by the public access point.

Also, in contrast to the previous description, the unmanned aerial vehicle 1 may communicate with the private access point and the owner of the access point may communicate with the public access point. The public access point may be set up to be accessible by a user who has undergone a predetermined registration process (such as a member of an online shopping site). The public access points may use the same SSID among a plurality of access points 2. In this manner, the security of communications between the unmanned aerial vehicle 1 and the private access points is improved, enabling safe operation of the unmanned aerial vehicle 1.

When the unmanned aerial vehicle 1 enters the communication range of the destination access point 2, it transmits the location information to the control center 3. The control center 3 notifies the user 4 that arrival is expected.

As described above, in the fourth embodiment, the unmanned aerial vehicle 1 uses a wireless LAN network formed by a plurality of wireless LAN access points, enabling the unmanned aerial vehicle 1 to transmit information during flight. In this manner, large volumes of data such as image data captured by the camera can be transmitted to the control center 3, enabling one to know in detail the flight state of the unmanned aerial vehicle 1. Also, by using the wireless LAN access points, it is possible to keep down communication costs.

Although embodiments regarding the delivery of packages by the unmanned aerial vehicle 1 were described, the present invention can also be applied to unmanned aerial vehicles 1 that fly along a predetermined path without delivering packages.

As described above, according to embodiments of the present invention, the unmanned aerial vehicle 1 communicates with the control center 3 through the access point 2 within a predetermined range, and communicates with the control center 3 through a telecommunications carrier network outside of the predetermined range, and thus, it is possible to detect with high accuracy the landing site 101 using signals from the access point 2 set up close to the landing site 101.

The predetermined range is the range at which the unmanned aerial vehicle 1 can communicate with the access point 2, and thus, detailed information on the landing site can be acquired through high volume communication through the access point 2.

Also, the unmanned aerial vehicle 1 verifies the identification information (SSID) of the access point 2 and notifies the control center 3 of its expected arrival to the landing site 101 through the access point 2 for which verification of the identification information was successful, and thus, the unmanned aerial vehicle 1 would not land at the wrong landing site because it would not connect to another access point 2 besides that of the destination.

Also, the pad 102, which includes an access point 2 that can communicate with the unmanned aerial vehicle 1 and indicates a landing site that can be visually confirmed from the air, is set at the delivery destination, and thus, there is no need to provide a large marker to be recognized from the air at the landing site, and a small landing site that can be set up in a small location may be used. In other words, it is possible to miniaturize the pad 102.

Also, the unmanned aerial vehicle 1 uses the strength of the signal transmitted from the access point 2 within the predetermined range to search for the landing site, and thus, the accuracy of finding the landing site can be improved.

The control center 3 verifies the code inputted at the delivery destination, and when verification is successful, determines that the package has arrived at the delivery destination, and thus, it is possible to reliably confirm receipt of the package.

In a case where the unmanned aerial vehicle 1 detects that the package has been retrieved, it notifies the control center 3 that the package has been retrieved, and after confirming that the package has been retrieved, the control center 3 issues a command to the unmanned aerial vehicle 1 to take off, enabling the unmanned aerial vehicle 1 to return to its base. In the predetermined range, the unmanned aerial vehicle 1 transmits images captured by the camera to the control center 3 through the access point 2, and the control center 3 displays the images transmitted from the unmanned aerial vehicle and transmits flight commands to the unmanned aerial vehicle 1, and thus, it is possible to control flight of the unmanned aerial vehicle 1 even in environments where autonomous flight is difficult.

In the predetermined range, the unmanned aerial vehicle 1 transmits location information to the control center 3 through the access point 2, and the control center 3 uses the location information transmitted from the unmanned aerial vehicle 1 and displays the location of the unmanned aerial vehicle 1 on a map, and thus, it is possible to display the location and flight direction of the unmanned aerial vehicle 1 in an easy to understand manner.

Also, in the predetermined range, the unmanned aerial vehicle 1 transmits attitude information to the control center 3 through the access point 2, and the control center 3 estimates the range captured by the images on the basis of the attitude information and location information and displays the range captured by the images on a map, and thus, it is possible to confirm the state of the periphery of the unmanned aerial vehicle 1 in cases in which it would be difficult to know such information by map alone.

Additionally, the unmanned aerial vehicle 1 communicates with the control center 3 while switching between the plurality of access points 902 to 904 and 2, and notifies the control center 3 of flight information through at least one access point, and thus, it is possible to always acquire information of the unmanned aerial vehicle 1 through high volume communication through the access point 2 during flight. Also, in-flight communication in this case does not go through a telecommunications carrier network, enabling a reduction in communication costs.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

What is claimed is:

1. A delivery system, comprising:
an unmanned aerial vehicle that delivers a package to a delivery destination;
a control server that manages delivery of the package; and
an access point set in a vicinity of a landing site of the unmanned aerial vehicle,
wherein the unmanned aerial vehicle is configured to:
communicate with the control server through the access point when inside a predetermined range; and
communicate with the control server through a telecommunications carrier network outside of the predetermined range.

2. The delivery system according to claim 1,
wherein the predetermined range is a range in which the unmanned aerial vehicle can communicate with the access point.

3. The delivery system according to claim 1,
wherein the unmanned aerial vehicle is configured to:
verify whether identification information transmitted from the access point coincides with identification information included in a delivery command; and
notify the control server of expected arrival to the landing site, through the access point in which verification of the identification information was successful.

4. The delivery system according to claim 1, further comprising a pad set up at the delivery destination, the pad having the access point and indicating the landing site so as to be able to be confirmed visually from above.

5. The delivery system according to claim 1, wherein the unmanned aerial vehicle is configured to search for the landing site by using a strength of a signal transmitted from the access point within the predetermined range.

6. The delivery system according to claim 1,
wherein the control server is configured to:
verify whether a code inputted at the delivery destination coinsides with a predetermined code; and
determine that the package has arrived at the delivery destination in a case where verification of the code is successful.

7. The delivery system according to claim 1,
wherein the unmanned aerial vehicle is configured to notify the control server that the package has been retrieved in a case of detecting that the package has been retrieved, and
wherein the control server is configured to issue a command to the unmanned aerial vehicle to take off after confirming that the package has been retrieved.

8. The delivery system according to claim 1,
wherein the unmanned aerial vehicle includes a camera that captures images of a periphery thereof,
wherein the unmanned aerial vehicle is configured to transmit the images captured by the camera to the control server through the access point when inside the predetermined range, and
wherein the control server is configured to:
generate data for displaying the images transmitted from the unmanned aerial vehicle; and
transmit a flight command to the unmanned aerial vehicle.

9. The delivery system according to claim 8,
wherein the unmanned aerial vehicle includes a positioning unit that acquires location information,
wherein the unmanned aerial vehicle is configured to transmit the location information to the control server through the access point when inside the predetermined range, and
wherein the control server is configured to generate data for displaying a location of the unmanned aerial vehicle on a map by using the location information transmitted from the unmanned aerial vehicle.

10. The delivery system according to claim 9,
wherein the unmanned aerial vehicle includes a sensor that acquires attitude information,
wherein the unmanned aerial vehicle is configured to transmit the attitude information to the control server through the access point when inside the predetermined range, and
wherein the control server is configured to:
estimate a range captured by the images on the basis of the attitude information and the location information; and
generate data for displaying on a map the range captured by the images.

11. The delivery system according to claim 1,
wherein the unmanned aerial vehicle is configured to:
communicate with the control server while switching among a plurality of the access points, and
transmit flight information to the control server through at least one of the access points.

12. A delivery method by which a delivery system delivers a package,
wherein the delivery system includes an unmanned aerial vehicle that delivers a package to a delivery destination, a control server that manages delivery of the package, and an access point set in a vicinity of a landing site of the unmanned aerial vehicle, and
wherein the method includes steps of:
communicating, by the unmanned aerial vehicle, with the control server through the access point when inside a predetermined range; and
communicating, by the unmanned aerial vehicle, with the control server through a telecommunications carrier network outside of the predetermined range.

13. The delivery method according to claim 12,
wherein the delivery system further includes a pad set up at the delivery destination, the pad having the access point and indicating the landing site so as to be able to be confirmed visually from above, and
wherein the delivery method includes a step of communicating, by the unmanned aerial vehicle, with the control server through the access point included in the pad when inside the predetermined range.

14. The delivery method according to claim 12,
wherein the unmanned aerial vehicle includes a camera that captures images of a periphery thereof,
wherein the delivery method further includes steps of:
transmitting, by the unmanned aerial vehicle, the images captured by the camera to the control server through the access point when inside the predetermined range,
generating, by the control server, data for displaying the images transmitted from the unmanned aerial vehicle, and
transmitting, by the control server, a flight command to the unmanned aerial vehicle.

15. The delivery method according to claim 12, further including steps of:
communicating, by the unmanned aerial vehicle, with the control server while switching among a plurality of the access points, and
transmitting, by the unmanned aerial vehicle, flight information to the control server through at least one of the access points.
